(19) United States
(12) Patent Application Publication
(10) Pub. No.: US 2010/0068333 A1
(43) Pub. Date: Mar. 18, 2010

(54) Methods for Enhancing the Palatability of Food Compositions

(76) Inventor: Fernando Qvyjt, Memphis, TN (US)

Correspondence Address: COLGATE-PALMOLIVE COMPANY, 909 RIVER ROAD, PISCATAWAY, NJ, 08855, US

(21) Appl. No.: 11/722,011

(22) PCT Filed: Dec. 12, 2005
(86) PCT No.: PCT/US05/45131

§ 371 Date: Nov. 11, 2008

Related U.S. Application Data
(60) Provisional application No. 60/636,789, filed on Dec. 16, 2004.

(51) Int. Cl. A23L 1/22; A23K 1/16; B65D 85/00

(52) U.S. Cl. 426/2; 426/538; 426/108; 426/87

(57) ABSTRACT

Methods for enhancing the palatability of food compositions by adding to the compositions a palatability enhancing amount of an extract of an herb or spice of the botanical genus Artemisia. The extract is added to the food compositions in an amount equivalent in flavorant effect to at least about 0.0001% by weight of tarragon essential oil. The resulting food compositions are more palatable to the animal and, therefore, help to ensure adequate food consumption by and the health and wellness of the animal.

### CROSS-REFERENCE TO RELATED APPLICATIONS

This application claims priority to U.S. Provisional Application Ser. No. 60/636,789, filed Dec. 16, 2004, the disclosure of which is incorporated herein by reference.

### BACKGROUND OF THE INVENTION

1. Field of the Invention

The present invention relates to methods for enhancing the palatability of food compositions and to food compositions having enhanced palatability.

2. Description of the Related Art

In designing foods for animals, including companion animals such as cats and dogs, optimal animal health or wellness through good nutrition is an important goal. However, even the most nutritious animal food is of little value if the animal rejects or refuses to eat the food or if the animal's intake of the food is restricted because it finds the food unpalatable.

Finicky animals, older animals, sick animals, and high energy animals often do not consume enough nutrients to maintain their weight and activity level. Particularly for older or sick animals, lack of interest in food and resulting low consumption can result in muscle deterioration, weakness and poor recovery of health. Low food consumption can ultimately result in hospitalization and/or death of the animal.

Cats in particular are notoriously finicky, fastidious or otherwise excessively selective in what they will eat.

Enticing an animal to eat can be an expensive and time consuming. Foods with varying moisture content, supplements, and treats have been developed to encourage animals to eat. However, these attempts are an imperfect solution to the problem. Methods for improving palatability, including methods that use herbs and spices, are known in the art. For example, U.S. Patent Application Publication No. 2003/0190343 discloses use of a mixture of natural herbs and spices as a palatability improving agent. Examples given therein of natural herbs and spices for use in such a mixture include allspice, anise, basil, bay, black pepper, caraway, cardamom, cassia, celery seed, cinnamon, clover, coriander, cumin, dill, fennel, ginger, marjoram, mustard, nutmeg, oregano, paprika, rosemary, saffron, sage, savory, tarragon, thyme, turmeric and white pepper. U.S. Pat. No. 4,514,431 discloses meat-flavored products including cat and dog foods. A recipe is given for a ground sausage mixture containing, inter alia, oils of black pepper, celery, cloves, coriander, cumin, ginger, mustard, nutmeg and pimenta berries, as well as oleoresin capsicum. European Patent No. 1 063 897 discloses a dual texture pet or animal food that can comprise ingredients such as rosemary, clove and parsley seed oils. U.S. Pat. No. 6,156,355 discloses various pet food formulations that comprise certain extracts or oils of herbs and spices, including for example rosemary extract, Yucca schidigera extract, parsley seed oil powder and ginger extract. U.S. Pat. No. 6,379,727 discloses a variety flavor pack for topical application to pet foods. The flavor packs reportedly comprise a multiplicity of different dry or liquid flavorant compositions, including oleoresin. U.S. Pat. No. 6,265,011 discloses a dog biscuit that can comprise dried tarragon. U.S. Pat. No. 6,495,176 discloses a breath-freshening pet food composition. The breath-freshening composition can comprise plant extracts including essential oils. Even though these methods have proven useful for enhancing the palatability of food compositions, there continues to be a need for new methods for improving the palatability of food compositions.

### SUMMARY OF THE INVENTION

The invention provides methods for enhancing the palatability of food compositions by adding to the composition a palatability enhancing amount of an extract of an herb or spice of the botanical genus Artemisia and compositions having enhanced palatability containing the extract. The extract is added to the food compositions in an amount equivalent in flavorant effect to at least about 0.0001% by weight of tarragon essential oil. The resulting food compositions are more palatable to the animal and, therefore, help to ensure adequate food consumption by and the health and wellness of the animal.

Additional or alternative advantages and benefits of the methods and compositions of the present invention will be apparent to one skilled in the art.

### DETAILED DESCRIPTION OF THE INVENTION

### Definitions

The terms “herb” and “spice” as descriptors of plant species or parts of plants are not clearly differentiated in the art and have overlapping meanings. These terms are used interchangeably herein.

The term “extract” means a preparation made from any part or parts of an herb or spice that comprises, generally in concentrated form, compounds that contribute to the characteristic flavor and/or aroma of the herb or spice. Extracts include without limitation essential oils, oleoresins, infusions, tinctures and natural extractives, including distillates. Extracts do not include crude plant parts, whether whole or ground. Considerable advantages are obtainable by use of an extract as provided herein, rather than by use of the corresponding herb or spice in crude form as proposed, for example, in above-cited U.S. Patent Application Publication No. 2003/0190343. Such advantages can include greater standardization and/or uniformity of flavorant effect, lower cost, improved cost stability, greater ease of processing, etc.

The term “flavorant” compound or ingredient means a compound or ingredient that, when it occurs naturally in a plant part, contributes to the characteristic flavor and/or aroma of the plant part, and/or, when extracted from a plant or synthesized, has a distinctive flavor that it imparts to a composition comprising that compound or ingredient. A “substantial flavorant ingredient” of an herb or spice or an extract thereof is a flavorant ingredient present in sufficient amount to have an organoleptically detectable effect on the flavor and/or aroma of the herb or spice or extract thereof. Typically, such an ingredient is present in an amount of at least about 1%, more typically at least about 5%, by weight of an essential oil of the herb or spice.

The term “enhanced” when referring to the palatability of a food composition comprising an herb or spice extract means palatability by comparison with an otherwise substantially identical food composition lacking only the herb or spice extract.

The term “single package” means that the components of a kit are physically associated in or with one or more containers and considered a unit for manufacture, distribution, sale, or use. Containers include, but are not limited to, bags, boxes, bottles, shrink wrap packages, stapled or otherwise affixed components, or combinations thereof. A single package may be containers of individual food compositions physically associated such that they are considered a unit for manufacture, distribution, sale, or use.

The term “virtual package” means that the components of a kit are associated by directions on one or more physical or virtual kit components instructing the user how to obtain the other components, e.g., in a bag containing one component and directions instructing the user to go to a website, contact a recorded message, view a visual message, or contact a caregiver or instructor, to obtain instructions on how to use the kit.

### The Invention

In one aspect, the present invention provides methods for enhancing the palatability of food compositions comprising adding to the composition a palatability enhancing amount of an extract of an herb or spice of the botanical genus Artemisia (“artemisia extract”). In another aspect, the invention provides methods for enhancing the palatability of food compositions comprising adding to the composition a palatability enhancing amount of an extract of an herb or spice that comprises as a substantial flavorant ingredient at least one compound having the Formula (I):

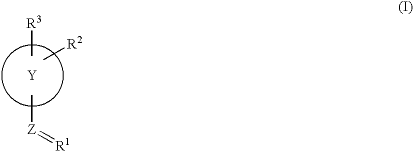

wherein:
Y is a six-membered ring selected from the group consisting of phenyl and cyclohexenyl rings;
Z is a linking moiety selected from the group consisting of —CH═, —C(CH₃)═ and —CH₂—CH═;
R¹ is a radical selected from the group consisting of ═CH₂, ═CH—CH₃, ═CH—CHO and ═CH—COOM where M is hydrogen, a monovalent ammonium, organic ammonium or alkali metal ion, or lower alkyl;
R² and R³ are radicals independently selected from the group consisting of hydrido, hydroxyl, lower alkyl and lower alkoxy; and
R³ is para and R² is meta to —Z═R¹.

For example, such a compound can have the Formula (II)

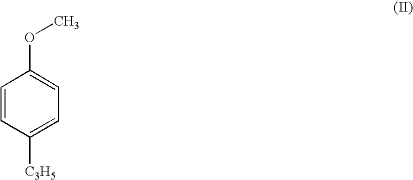

### or the Formula (III)

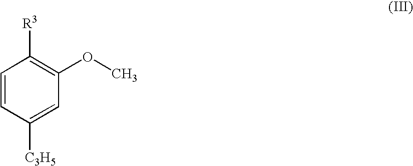

where R³ is hydroxyl (OH) or methoxy (OCH₃). The Artemisia extract and/or the compound(s) of Formula (I) are added to the food compositions in an amount equivalent in flavorant effect to at least about 0.0001% by weight of tarragon essential oil.

In another aspect, the invention provides food compositions having enhanced palatability comprising a palatability enhancing amount of an artemisia extract and/or the compound(s) of Formula (I). The composition contains the artemisia extract, the compound(s) of Formula (I), or a combination thereof in an amount equivalent in flavorant effect to at least about 0.0001% by weight of tarragon essential oil.

The methods and compositions of the present invention are useful for enhancing the palatability of food compositions for a variety of human and non-human animals, including avian, bovine, canine, equine, feline, hicrine, murine, ovine, and porcine animals, particularly companion animals such as cats and dogs. The food compositions comprising an extract(s) of the present invention exhibit surprisingly high palatability to an animal. Furthermore, the methods of the invention impart surprisingly high palatability to a food that otherwise is of inferior palatability to an animal. The methods of the invention are especially beneficial when an animal is, or has become, finicky, has poor appetite, or is in ill health, all of which can occur in animals of all ages but especially in aged animals. The methods are especially beneficial when the food composition is one to which the animal is unaccustomed, or contains ingredients or a balance of ingredients designed to improve health or wellness with less emphasis on palatability.

Tarragon essential oil is an example of the artemisia extract of the present invention. However, as is clear to skilled artisans, when tarragon essential oil is indicated, any artemisia extract or any herb or spice extract that comprises a compound of Formula (I) in a substantial flavorant amount can be substituted for tarragon essential oil, e.g., essential oils, oleoresins, infusions, tinctures, and natural extractives, including distillates.

Numerous compounds of Formula (I) are known to have flavorant properties. For example, Formula (II) encompasses estragole (1-methoxy-4-(2-propenyl)benzene) and anethole (1-methoxy-4-(1-propenyl)benzene) and Formula (III) encompasses eugenol (1-hydroxy 2-methoxy-4-(2-propenyl)benzene), methyl eugenol (1,2-dimethoxy-4-(2-propenyl)benzene), and isoeugenol (1-hydroxy 2-methoxy-4-(1-propenyl)benzene). Formula (I) also encompasses flavorant compounds such as cinnamaldehyde (3-phenyl-2-propenal), α-methylcinnamaldehyde and cinnamic acid (3-phenyl-2-propenoic acid) and its salts and lower alkyl esters such as methyl cinnamate, ethyl cinnamate and n-butyl cinnamate. Formula (I) also encompasses the flavorant limonene (p-mentha-1,8-diene) having the structure:

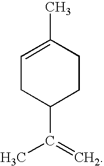

Limonene can be present in the compositions of the present invention in its d- or l-configuration or as a racemic mixture of d- and l-forms.

Tarragon essential oil, which can contain terpenes, anethole, estragole, eugenol, isoeugenol and methyl eugenol, is the standard for the present invention. Where tarragon essential oil is used in a food composition, the amount used should be at least about 0.0001% by weight. Where an herb or spice extract other than tarragon essential oil is used, the amount used should be an amount equivalent in flavorant effect to at least about 0.0001% by weight of tarragon essential oil, in content of anethole, estragole, eugenol, methyl eugenol and/or isoeugenol, or in palatant effect. A tarragon essential oil equivalent amount of any such extract can readily be determined by one of ordinary skill in the art.

Tarragon is an herbaceous plant of the species Artemisia dracunculus. Essential oils from other Artemisia species can similarly contain terpenes, anethole, estragole, eugenol, isoeugenol, and methyl eugenol. Accordingly, in one embodiment an essential oil or other extract for the purposes of the present invention can be derived from any herb containing anethole, estragole, eugenol, isoeugenol and/or methyl eugenol, including but not limited to tarragon (A. dracunculus), wormwood (A. absinthium), genepi (A. glacialis), mugwort (A. vulgaris or A. pontica), southernwood (A. abrotanum), mountain wormwood (A. valesiaca) and other Artemisia species (for example A. annua, A. myriantha, A. tridentata and A. caruthii).

In various embodiments, the extract comprises estragole, anethole, or any one of or any combination of two or more of anethole, estragole, eugenol, isoeugenol, and methyl eugenol. In one embodiment, the extract comprises a tarragon essential oil equivalent amount of at least about 0.0001% of an artemisia extract such as those obtained from Artemisia dracunculus, A. absinthium, A. glacialis, A. vulgaris, A. abrotanum, A. valesiaca, A. annua, A. myriantha, A. tridentata or A. caruthii.

An extract useful according to the invention can be derived from a plant of the genus Artemisia or from any other anethole-, estragole-, eugenol-, isoeugenol- and/or methyl eugenol-containing herb or spice. Non-limiting examples of such herbs or spices other than those listed above include anise (Pimpinella anisum), sweet basil (Ocimum basilicum), bay (Pimenta racemosa), bois de rose (Rubas species of section Eubatus), boldo (Peumus boldus), calamus (Acorus calamus), camphor tree (Cinnamomum camphora), cananga and ylang-ylang (Cananga odorata), cascarilla (Croton eluteria), cinnamon (Cinnamomum zeylanicum, C. loureirii and C. cassia), citronella (Cymbopogon winterianus and C. nardus), clove (Eugenia caryophyllata), chervil (Anthriscus cerefolium), Indian dill (Anethum sowa and Peucedanum graveolens), fennel (Foeniculum vulgare) including common fennel and sweet fennel, geranium (Pelargonium graveolens, P. roseum, P. radula, P. capitatum, P. fragrans and P. odoratissimum), grains of paradise (Aframomum meleguata), immortelle (Helichrysum angustifolium), jasmine (Jasminum officinale and other species), labdanum (Cistus ladaniferus and C. creticus), bay laurel (Laurus nobilis), sweet marjoram (Origanum majorana), myrrh (Commiphora molmol, C. abyssinica and other species), nutmeg (Myristica fragrans), patchouly (Pogostemon cablin and P. heyneanus), pimenta and allspice (Pimenta officinalis), sassafras (Sassafras albidum), star anise (Illicium verum), tuberose (Polyanthes tuberosa) and walnut (Juglans regia and other species).

Examples of extracts useful according to this embodiment include essential oils of tarragon, bay, basil, anise or nutmeg in an amount equivalent in flavorant effect to at least about 0.0001% by weight tarragon essential oil.

In some embodiments, the invention provides methods for enhancing the palatability of companion animal food compositions by adding a palatability enhancing amount of an extract of the present invention to the compositions and companion animal food compositions produced according to such methods. Generally, the extract is added to the food compositions in an amount equivalent to at least about 0.0001% by weight of tarragon essential oil. In one embodiment, the methods comprise adding to a companion animal food composition a tarragon essential oil equivalent amount of at least about 0.0001% by weight of an herb or spice extract comprising at least one of anethole, estragole, eugenol, isoeugenol, and methyl eugenol.

In another embodiment, the compositions and methods further comprise a second extract, e.g., an extract from an essential oil of an herb or spice selected from the group consisting of anise, arnica, basil, bergamot, calendula, caraway, chamomile, cinnamon, citrus (including lemon), elder, eucalyptus, fir needle, garlic, hops, juniper, lavender, lemon balm, licorice, marjoram, oregano, passionflower, peppermint, primrose, thyme, and vanilla. More particularly, the second extract can be derived from cinnamon, citrus (including lemon), eucalyptus, lavender, oregano, peppermint, thyme or vanilla. Compositions and methods of this embodiment are beneficial in reducing the odor of animal excreta, including stool odor and flatulence odor, when the compositions are fed to animals, including companion animals such as dogs and cats. Thus, the invention provides a method for enhancing the palatability of a food composition and reducing the odor of animal excreta that results from consumption of such composition by feeding to the animal a food composition comprising (1) an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla and (2) at least one of a palatability enhancing amount of an extract of an herb or spice of the botanical genus Artemisia or a palatability enhancing amount of an extract of an herb or spice that comprises as a substantial flavorant ingredient at least one compound of Formula (I).

Food compositions of the present invention include, for example, canned moist pet foods, extruded dry pet foods, supplements, and treats. All are adapted for consumption by an animal such as a dog or cat, but are not necessarily suitable for human consumption. In one embodiment the food composition, by virtue of the quality or origin of the ingredients or means of processing, is not adapted for human consumption. Any pet food can benefit from inclusion of an herb or spice extract as defined herein, but in one embodiment the pet food is one having a major (at least about 25%, for example at least about 50%, by weight) component derived from animal (e.g., mammal, bird or fish) proteinaceous tissues including muscle tissues and offal, optionally with a carbohydrate source such as cereal grains.

The herb or spice extract can be distributed more or less homogeneously through the food composition. Alternatively, the herb or spice extract can be present in whole or in part on surfaces of food pieces such as meat chunks, dry kibbles or individual treats such as dog biscuits.

The herb or spice extract should be present in an amount that is not toxic or otherwise deleterious to the health of a companion animal consuming a normal quantity of the food composition. In particular, the extract should be present at a concentration that does not cause undesirable effects on digestion, particularly long-term effects lasting several days or longer. Undesirable effects on digestion can include, for example, constipation, or diarrhea.

Generally, the methods provide and the food compositions comprise the extract(s) of the invention in palatability enhancing amounts from about 0.0001% to about 0.1%, from about 0.001% to about 0.05%, or from about 0.002% to about 0.01%, expressed as tarragon essential oil equivalent. Where the extract is localized on surfaces of food pieces, local concentrations can exceed those suggested here, but the overall concentration in the food composition as a whole will generally be in these ranges.

In preparing a composition of the present invention, the components of the food composition are adjusted so that the herb or spice extract is present in the composition at a desired concentration. The herb or spice extract can, for example, be incorporated into the food composition during formulation, such as during and/or after mixing of other components of the composition. Distribution of these components into the composition can be accomplished by any conventional method including standard mixing procedures.

Food compositions of the present invention can be prepared in a wet or containerized (e.g., canned or in pouches) form using conventional pet food processes. In one embodiment, ground animal (e.g., mammal, poultry, fish and/or seafood) proteinaceous tissues are mixed with other ingredients, including for example animal fats and vegetable oils, cereal grains, other nutritionally balancing ingredients, special purpose additives (e.g., vitamin and mineral mixtures, inorganic salts, cellulose and beet pulp, bulking agents, and the like); and water sufficient for processing is also added. These ingredients typically are mixed in a vessel suitable for heating while blending the components. Heating of the mixture can be effected in any suitable manner, such as, for example, by direct steam injection or by using a vessel fitted with a heat exchanger. Following addition of the last of these ingredients, the mixture is heated in a pre-cooking step to a temperature of up to about 100° C. Higher temperatures can be acceptable, but can be commercially impractical without use of other processing aids. When heated to the appropriate temperature, the material is typically in the form of a thick liquid. The thick liquid is filled into suitable containers such as cans, jars, pouches or the like. A lid is applied, and the container is hermetically sealed. The sealed containers are then placed into conventional equipment designed to sterilize the contents. This is usually accomplished by heating to a temperature of at least about 110° C. for an appropriate time, which is dependent on, for example, the temperature used and the composition. Products can also be prepared by an aseptic process wherein the contents are heated to commercial sterility before being packaged in sterilized containers. The herb or spice extract can be added to containerized pet food products before, during, or after the pre-cooking step.

Food compositions of the present invention can be prepared in a dry form using conventional processes. In one embodiment, dry ingredients, including, for example, animal protein sources, plant protein sources, grains, minerals, etc., are ground and mixed together. Moist or liquid ingredients, including fats, oils, animal protein sources, water, etc., are then added to and mixed with the dry mix. The mixture is then processed into kibbles or similar dry pieces. Kibble is often formed using an extrusion process in which the mixture of dry and wet ingredients is subjected to mechanical work at a high pressure and temperature, and forced through small openings and cut off into kibble by a rotating knife. The wet kibble is then dried and optionally coated with one or more topical coatings which can include, for example, flavors, fats, oils, powders, and the like. Kibble also can be made from the dough using a baking process, rather than extrusion, wherein the dough is placed into a mold before dry-heat processing. Kibble also can be made from a food matrix undergoing pelletization.

It is important to note that the herb or spice extract can be incorporated into the food composition by addition to the above-described mixtures before extrusion or by coating extruded kibble or pellets with the extract as an ingredient of a topical coating. For example, an essential oil can be added to liquids in a dry processing line, to a pre-conditioner composition or to a coating composition.

In one embodiment, the food composition is a nutritional supplement comprising an herb or spice extract as defined herein. Supplements include, for example, a pet food used with another pet food to improve the nutritive balance or performance of the total. Supplements include compositions that are fed undiluted as a supplement to other pet foods, offered free choice with other parts of an animal's ration that are separately available, or diluted and mixed with an animal's regular food to produce a complete diet. The AAFCO, for example, provides a discussion relating to supplements in the American Feed Control Officials, Inc. Official Publication (2003), at p. 220. Supplements can be in various forms including, for example, powders, liquids, syrups, pills, encapsulated compositions, etc.

In another embodiment, the composition is a dog or cat treat comprising the herb or spice extract. Treats include, for example, compositions that are given to an animal to entice the animal to eat during a non-meal time. Treats for canines include dog biscuits, for example in the shape of dog bones. Treats can be nutritional, wherein the composition comprises one or more nutrients, and can, for example, have a composition as described above for a pet food. Non-nutritional treats encompass any other treats that are non-toxic. The herb or spice extract can be present in a coating on the surface of the treat, or incorporated into the treat, or both.

An herb or spice extract can, if desired, be encapsulated in pet food systems. An herb or spice extract can be added to a palatant (such as a digest or broth) at any time during processing of the palatant.

Palatability enhancement can be measured by any procedure known in the art, but in an illustrative procedure enhanced palatability can be quantified by determining an intake ratio in a palatability test. In one type of test, illustratively presented in Examples 1 and 2, a test formulation (for example a food composition of the present invention) is offered together with a control or comparator formulation (for example a food composition lacking an herb or spice extract as described herein) for a predetermined duration. A suitable duration is about 45 minutes for a dog or 24 hours for a cat, but this can be varied if desired. The weight ratio of test food consumed to total food (test food plus control food) consumed during that period is a measure of intake ratio and of relative palatability of the two foods. An intake ratio substantially greater than about 0.5 is indicative of enhanced palatability.

The herb or spice extract can be added during manufacturing of the food composition, for example by a process of mixing or coating as indicated above. In one embodiment, the herb or spice extract is added to a companion animal's food by the person responsible for feeding the companion animal.

For this purpose, the herb or spice extract can be used as such, for example as an undiluted essential oil. Typically, however, it is more convenient, and reduces risk of accidental over-addition of the extract, to provide the extract in diluted or dispersed form in a suitable carrier such as vegetable oil or edible powder. A powder comprising the herb or spice extract can be sprinkled on an animal's food immediately before feeding. Alternatively, a liquid comprising the herb or spice extract can be sprayed on the food. Such powder or liquid compositions are described herein as “palatability enhancer compositions” and can be thought of as “seasonings”. They can be applied to the top of a serving of pet food and/or can, if desired, be mixed into the food. The use of palatability enhancer compositions or seasonings comprising an herb or spice extract as specified herein to enhance palatability of a pet food composition is an embodiment of the present invention.

In a further embodiment, methods are provided for enhancing the palatability of a food composition to a companion animal comprising adding to the composition a palatability enhancing amount of at least one flavorant compound of Formula (I), illustratively at least one compound of Formula (II) or (III). The compound can illustratively be anethole, estragole, eugenol, isoeugenol, or methyl eugenol. Optionally, any combination of two or more of anethole, estragole, eugenol, isoeugenol, and methyl eugenol can be added according to the methods of the invention. Flavorant compounds useful according to the present embodiment can be of natural or synthetic origin.

According to this embodiment, the at least one flavorant compound can be added to the food composition in any palatability enhancing amount that is not toxic or otherwise deleterious to the health of the animal, for example from about 0.0001% to about 0.1%, or from about 0.001% to about 0.05%, or from about 0.002% to about 0.01%, by weight of the food composition.

In a further aspect, the present invention provides a kit for administering a food composition having enhanced palatability to an animal comprising in separate containers in a single package at least one ingredient suitable for consumption by an animal and a palatability enhancing amount of at least one of (1) an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla and (2) at least one of a palatability enhancing amount of an extract of an herb or spice of the botanical genus Artemisia or a palatability enhancing amount of an extract of an herb or spice that comprises as a substantial flavorant ingredient at least one compound of Formula (I). In additional embodiments, the kit further comprises in separate containers in a single package or in separate containers in a virtual package, as appropriate for the kit component, one or more of (1) instructions for how to combine the extracts and the ingredient(s) to produce a composition for animal consumption having enhanced palatability, (2) instructions for how to use the compositions of the present invention, particularly for the benefit of the animal, and (3) an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla. When the kit comprises a virtual package, the kit is limited to instructions in a virtual environment in combination with one or more physical kit components. The kit contains the palatability enhancing extracts in amounts sufficient to enhance the palatability of the composition. Generally, kits contain such extracts in amounts sufficient to produce a composition comprising the extract in amounts equivalent in flavorant effect to at least about 0.0001% by weight of tarragon essential oil. Typically, the extracts and the food composition ingredient(s) are admixed just prior to consumption by an animal. In one embodiment, the kit contains a packet of palatability enhancing extracts and a container of food for consumption by an animal. The kit may contain additional items such as a device for mixing the extracts and ingredient or a device for containing the admixture, e.g., a food bowl. In another embodiment, the extract(s) is mixed with additional nutritional supplements such as vitamins and minerals that promote good health in an animal.

In another aspect, the present invention provides a means for communicating information about or instructions for using the compositions, methods, and/or kits of the present invention to increase palatability of food compositions, prepare food compositions having enhanced palatability, and increase food consumption by an animal, as appropriate. The communicating means comprises a document, digital storage media, optical storage media, audio presentation, or visual display containing the information or instructions. Preferably, the communication is a displayed web site or a brochure, product label, package insert, advertisement, or visual display containing such information or instructions. Useful information includes one or more of (1) methods and techniques for combining and administering the extracts and ingredient(s) and (2) contact information for patients to use if they have a question about the invention and its use. Useful instructions include amounts for mixing and administration amounts and frequency. The communication means is useful for instructing on the benefits of using the present invention and communicating the approved methods for administering the invention to an animal.

This invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise. Similarly, the words “comprise”, “comprises”, and “comprising” are to be interpreted inclusively rather than exclusively.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All patents, patent applications, and publications mentioned herein are incorporated herein by reference to the extent allowed by law for the purpose of describing and disclosing the compounds, processes, techniques, procedures, technology, articles, and other compositions and methods disclosed therein that might be used with the present invention. However, nothing herein is to be construed as an admission that the invention is not entitled to antedate such disclosure by virtue of prior invention.

### EXAMPLES

This invention can be further illustrated by the following examples of preferred embodiments thereof, although it will be understood that these examples are included merely for purposes of illustration and are not intended to limit the scope of the invention unless otherwise specifically indicated.

### Example 1

Dry cat food products were prepared from existing formulas with the additional inclusion of tarragon essential oil.

Table 1 and Table 2 show results of a palatability study in cats offered test foods that were dry cat foods prepared with and without addition of tarragon essential oil to a pre-conditioner composition during preparation of the foods. Four control foods were provided.

An intake ratio (IR), defined as the average ratio of test food ingested to total food ingested, was determined for each test food in comparison with the corresponding control food. Each animal received a pre-weighed food dish containing the test food and, simultaneously, a pre-weighed food dish containing the control food. The food dishes were left with the animal for 24 hours, at the end of which the food dishes were removed and reweighed to determine intake ratio using the Formula:

IR=A/(A+B)

where A is the amount of the test food consumed by the animal and B is the amount of the control food consumed by the animal.

In Tables 1 to 4, “parity” means no significant preference was observed for the test food over the indicated control OR close to 0.5), and “win” means that the test food was preferred over the indicated control (IR substantially greater than 0.5), i.e., found more palatable on average by the cats in this study. Where two or more sets of data are shown for a single test food formula, these represent results of separate tests.

TABLE 1
Palatability Results For Dry Cat Food Formulas

| | | | Palat- |
|---|---|---|---|
| Tarragon | | Intake | ability |
| oil (%) | Control food composition | ratio | result |
| 0 | Medi-Cal ® Weight Control | 0.59 | parity |
| 0.001 | Medi-Cal ® Weight Control | 0.67 | win |
| 0.002 | Medi-Cal ® Weight Control | 0.85 | win |
| 0.005 | Medi-Cal ® Weight Control | 0.89 | win |
| | | 0.81 | win |
| 0 | Royal Canin Vet Diet ® Diabetics | 0.22 | loss |
| 0.001 | Royal Canin Vet Diet ® Diabetics | 0.89 | win |
| 0.002 | Royal Canin Vet Diet ® Diabetics | 0.60 | parity |
| 0.005 | Royal Canin Vet Diet ® Diabetics | 0.76 | win |
| 0 | Medi-Cal ® Reducing Formula | 0.43 | parity |
| 0.001 | Medi-Cal ® Reducing Formula | 0.37 | loss |
| 0.002 | Medi-Cal ® Reducing Formula | 0.57 | parity |
| 0.005 | Medi-Cal ® Reducing Formula | 0.69 | win |
| | | 0.58 | parity |
| 0 | Royal Canin Vet Diet ® Caloric Control | 0.22 | loss |
| 0.001 | Royal Canin Vet Diet ® Caloric Control | 0.14 | loss |
| 0.002 | Royal Canin Vet Diet ® Caloric Control | 0.44 | parity |
| 0.005 | Royal Canin Vet Diet ® Caloric Control | 0.54 | parity |

In this study, dry cat food with addition of tarragon oil, especially in an amount of 0.002% or higher, generally exhibited a higher intake ratio than the food lacking tarragon oil, regardless of the control food composition used. Addition of tarragon oil was able to elevate palatability to result in a “win” or at least “parity” with respect to the control food in each case.

TABLE 2
Palatability Results For Dry Cat Food Formulas

| | | | Palat- |
|---|---|---|---|
| Tarragon | | Intake | ability |
| oil (%) | Control food composition | ratio | result |
| 0.0005 | Royal Canin Vet Diet ® Diabetics | 0.61 | win |
| 0.001 | Royal Canin Vet Diet ® Diabetics | 0.63 | win |
| 0.0005 | Royal Canin Vet Diet ® Caloric Control | 0.44 | parity |
| 0.001 | Royal Canin Vet Diet ® Caloric Control | 0.43 | parity |

### Example 2

Dry dog food products were prepared from existing formulas with the additional inclusion of tarragon essential oil.

Table 3 and Table 4 show results of a palatability study in dogs offered test foods that were dry dog foods prepared with and without addition of tarragon essential oil to a pre-conditioner composition during preparation of the foods. As indicated by the fourth column of Table 3, the kibble density of some formulas was varied from low to high in this study. Variation of kibble density was achieved by changing extrusion pressure or by changing ingredient rates and/or densities. Six control foods were provided.

An intake ratio (IR), defined as the average ratio of test food ingested to total food ingested, was determined for each test food in comparison with the corresponding control food. Each animal received a pre-weighed food dish containing the test food and, simultaneously, a pre-weighed food dish containing the control food. The food dishes were left with the animal for 45 minutes, at the end of which the food dishes were removed and reweighed to determine intake ratio as described above.

TABLE 3
Palatability Results For Dry Dog Food Formulas

| Tarra- | | | | Palat- |
|---|---|---|---|---|
| gon | | | Intake | ability |
| oil (%) | Control food composition | Density | ratio | result |
| 0 | Royal Canin Vet Diet ® Diabetics | low | 0.27 | loss |
| | | high | 0.44 | parity |
| 0.001 | Royal Canin Vet Diet ® Diabetics | low | 0.25 | loss |
| | | high | 0.34 | loss |
| | | high | 0.31 | loss |
| 0.002 | Royal Canin Vet Diet ® Diabetics | | 0.45 | parity |
| | | | 0.28 | loss |
| 0.005 | Royal Canin Vet Diet ® Diabetics | | 0.20 | loss |
| | | | 0.38 | loss |
| | | | 0.17 | loss |
| 0 | Purina Vet Diet ® OM | high | 0.39 | loss |
| | | | 0.38 | parity |
| 0.001 | Purina Vet Diet ® OM | | 0.66 | win |
| 0.002 | Purina Vet Diet ® OM | | 0.45 | parity |
| 0.005 | Purina Vet Diet ® OM | | 0.22 | loss |
| | | | 0.38 | loss |
| 0 | Medi-Cal ® Weight Control | low | 0.20 | loss |
| 0.001 | Medi-Cal ® Weight Control | | 0.41 | parity |
| 0.002 | Medi-Cal ® Weight Control | | 0.46 | parity |
| 0.005 | Medi-Cal ® Weight Control | | 0.47 | parity |
| | | | 0.33 | loss |

TABLE 4
Palatability Results For Dry Dog Food Formulas

| | | | Palat- |
|---|---|---|---|
| Tarragon | | Intake | ability |
| oil (%) | Control food composition | ratio | result |
| 0 | Royal Canin Vet Diet ® Caloric Control | 0.08 | loss |
| 0.001 | Royal Canin Vet Diet ® Caloric Control | 0.32 | loss |
| | | 0.27 | loss |
| 0.002 | Royal Canin Vet Diet ® Caloric Control | 0.46 | parity |
| | | 0.33 | loss |
| 0.005 | Royal Canin Vet Diet ® Caloric Control | 0.29 | loss |
| 0 | Purina Vet Diet ® OM | 0.10 | loss |
| 0.001 | Purina Vet Diet ® OM | 0.40 | parity |
| 0.002 | Purina Vet Diet ® OM | 0.52 | win |
| 0.005 | Purina Vet Diet ® OM | 0.54 | parity |
| 0 | Medi-Cal ® Fiber Formula | 0.29 | loss |
| 0.001 | Medi-Cal ® Fiber Formula | 0.63 | win |
| 0.002 | Medi-Cal ® Fiber Formula | 0.65 | win |
| 0.005 | Medi-Cal ® Fiber Formula | 0.43 | parity |

Referring to the data, addition of tarragon oil, especially at low percentages, to a dry dog food generally increased the intake ratio when compared to a dog food lacking tarragon oil.

In the specification, there have been disclosed typical preferred embodiments of the invention and, although specific terms are employed, they are used in a generic and descriptive sense only and not for purposes of limitation, the scope of the invention being set forth in the following claims. Obviously many modifications and variations of the present invention are possible in light of the above teachings. It is therefore to be understood that within the scope of the appended claims the invention may be practiced otherwise than as specifically described.

What is claimed is:

1. A food composition comprising a palatability enhancing amount of an extract of an herb or spice of the botanical genus Artemisia.

2. The composition of claim 1 comprising the extract in amounts equivalent in flavorant effect to at least about 0.0001% by weight of tarragon essential oil.

3. The composition of claim 1 wherein the herb or spice is selected from the group consisting of tarragon, mugwort, wormwood, and genepi.

4. The composition of claim 1 wherein the extract is an essential oil, an oleoresin, an infusion, a tincture, or a natural extractive.

5. The composition of claim 1 wherein the extract is tarragon essential oil.

6. The composition of claim 5 wherein the tarragon essential oil is present in an amount of about 0.0001% to about 0.1% by weight.

7. The composition of claim 1 further comprising an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla.

8. A method for enhancing the palatability of a food composition comprising adding to the composition a palatability enhancing amount of an extract of an herb or spice of the botanical genus Artemisia.

9. The method of claim 8 wherein the extract is added in amounts equivalent in flavorant effect to at least about 0.0001% by weight of tarragon essential oil.

10. The method of claim 8 wherein the herb or spice is selected from the group consisting of tarragon, mugwort, wormwood and genepi.

11. The method of claim 8 wherein the extract is an essential oil, an oleoresin, an infusion, a tincture, or a natural extractive.

12. The method of claim 8 wherein the extract is tarragon essential oil.

13. The method of claim 12 wherein the tarragon essential oil is added in an amount of about 0.0001% to about 0.1% by weight.

14. A food composition comprising a palatability enhancing amount of an extract of an herb or spice that comprises as a substantial flavorant ingredient at least one compound having the Formula (I): 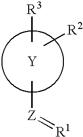
wherein:
Y is a six-membered ring selected from the group consisting of phenyl and cyclohexenyl rings;
Z is a linking moiety selected from the group consisting of —CH═, —C(CH₃)═ and —CH₂—CH═;
R¹ is a radical selected from the group consisting of ═CH₂, ═CH—CH₃, ═CH—CHO and ═CH—COOM where M is hydrogen, a monovalent ammonium, organic ammonium or alkali metal ion, or lower alkyl;
R² and R³ are radicals independently selected from the group consisting of hydrido, hydroxyl, lower alkyl and lower alkoxy; and
R³ is para and R² is meta to —Z═R¹.

15. The composition of claim 14 comprising the extract in amounts equivalent in flavorant effect to at least about 0.0001% by weight of tarragon essential oil.

16. The composition of claim 14 wherein the herb or spice is selected from the group consisting of tarragon, mugwort, wormwood, and genepi.

17. The composition of claim 14 wherein the compound is selected from the group consisting of anethole, estragole, eugenol, isoeugenol, and methyl eugenol.

18. The composition of claim 14 wherein the compound is estragole.

19. The composition of claim 14 wherein the compound is anethole.

20. The composition of claim 14 further comprising an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla.

21. A method for enhancing the palatability of a food composition comprising adding to the composition a palatability enhancing amount of an extract of an herb or spice that comprises as a substantial flavorant ingredient at least one compound having the Formula (I): 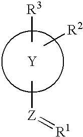
wherein:
Y is a six-membered ring selected from the group consisting of phenyl and cyclohexenyl rings;
Z is a linking moiety selected from the group consisting of —CH═, —C(CH₃)═ and —CH₂—CH═;
R¹ is a radical selected from the group consisting of ═CH₂, ═CH—CH₃, ═CH—CHO and ═CH—COOM where M is hydrogen, a monovalent ammonium, organic ammonium or alkali metal ion, or lower alkyl;
R² and R³ are radicals independently selected from the group consisting of hydrido, hydroxyl, lower alkyl and lower alkoxy; and
R³ is para and R² is meta to —Z═R¹.

22. The method of claim 21 wherein the extract is added in an amount equivalent in flavorant effect to at least about 0.0001% by weight of tarragon essential oil.

23. The method of claim 21 wherein the compound is selected from the group consisting of anethole, estragole, eugenol, isoeugenol, and methyl eugenol.

24. The method of claim 21 wherein the compound is estragole.

25. The method of claim 21 wherein the compound is anethole.

26. A method for enhancing the palatability of a food composition and reducing the odor of animal excreta that results from consumption of such composition comprising feeding to the animal a food composition comprising:
(1) an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla; and
(2) at least one of a palatability enhancing amount of an extract of an herb or spice of the botanical genus Artemisia or a palatability enhancing amount of an extract of an herb or spice that comprises as a substantial flavorant ingredient at least one compound of Formula (I).

27. A method for enhancing the palatability of a food composition comprising adding to the composition a palatability enhancing amount of an extract of an herb or spice selected from the group consisting of anise, sweet basil, bay, bois de rose, boldo, calamus, camphor tree, cananga, ylang-ylang, cascarilla, cinnamon, citronella, clove, chervil, Indian dill, common fennel, sweet fennel, geranium, grains of paradise, immortelle, jasmine, labdanum, bay laurel, sweet marjoram, myrrh, nutmeg, patchouly, pimenta, allspice, sassafras, star anise, tuberose and walnut.

28. The method of claim 27 wherein the extract is an essential oil.

29. A kit comprising in separate containers in a single package at least one ingredient suitable for consumption by an animal and a palatability enhancing amount of at least one of (1) an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla and (2) at least one of a palatability enhancing amount of an extract of an herb or spice of the botanical genus Artemisia or a palatability enhancing amount of an extract of an herb or spice that comprises as a substantial flavorant ingredient at least one compound of Formula (I).

30. The kit of claim 29 further comprising in separate containers in a single package or in separate containers in a virtual package, as appropriate for the kit component, one or more of (1) instructions for how to combine the extracts and the ingredient(s) to produce a composition for animal consumption having enhanced palatability, (2) instructions for how to use the compositions of the present invention, particularly for the benefit of the animal, and (3) an extract from an essential oil of an herb or spice selected from the group consisting of anise, arnica, basil, bergamot, calendula, caraway, chamomile, cinnamon, citrus, elder, eucalyptus, fir needle, garlic, hops, juniper, lavender, lemon balm, licorice, marjoram, oregano, passionflower, peppermint, primrose, thyme, and vanilla.

31. The kit of claim 29 comprising palatability enhancing extracts in amounts sufficient to produce a composition comprising the extract in amounts equivalent in flavorant effect to at least about 0.0001% by weight of tarragon essential oil.

32. A means for communicating information about or instructions for using the compositions, methods, or kits of the invention comprising a document, digital storage media, optical storage media, audio presentation, or visual display containing the information or instructions.

33. The means of claim 32 selected from the group consisting of a displayed web site, brochure, product label, package insert, advertisement, or visual display.
